(19) United States
(12) Patent Application Publication
(10) Pub. No.: US 2004/0220347 A1
(43) Pub. Date: Nov. 4, 2004

(54) Process for reducing ketocarboxylic esters

(76) Inventors: John Meurig Thomas, Cambridge (GB); Brian F. G. Johnson, Cambridge (GB); Robert Raja, Milton (GB); Matthew David Jones, Cambrige (GB)

Correspondence Address: LANXESS CORPORATION, PATENT DEPARTMENT/ BLDG 14, 100 BAYER ROAD, PITTSBURGH, PA, 15205-9741, US

(21) Appl. No.: 10/771,651

(22) Filed: Feb. 3, 2004

(30) Foreign Application Priority Data
Feb. 12, 2003 (DE) 10305946.6

(51) Int. Cl. C08F 261/00

(52) U.S. Cl. 525/259

(57) ABSTRACT

The present invention relates to a process for preparing enantiomerically enriched alpha- and beta-hydroxycarboxylic esters from the corresponding ketocarboxylic esters and also relates to immobilized transition metal complexes usable therefor.

### BACKGROUND OF THE INVENTION

1. Field of the Invention

The present invention relates to a process for preparing enantiomerically enriched alpha- and beta-hydroxycarboxylic esters from the corresponding ketocarboxylic esters and also relates to immobilized transition metal complexes usable therefor.

2. Brief Description of the Prior Art

Enantiomerically enriched alpha- and beta-hydroxycarboxylic esters are valuable reagents for optical resolution and important intermediates in the preparation of pharmaceuticals and agrochemicals. Customarily, enantiomerically enriched alpha- and beta-hydroxycarboxylic esters are obtained by the process of catalytically hydrogenating the corresponding alpha- and beta-ketocarboxylic esters, usually using transition metal complexes having chiral phosphines as ligands as catalysts (see, for example, Genet et al., Tetrahedron, Asymmetry, 1994, 5(4), 675-690). A disadvantage of chiral phosphines is their high cost and oxidation sensitivity, which is why they are used on the industrial scale predominantly in homogeneous processes, if at all.

Alternatively, processes using platinum or nickel catalysts modified by quinchonaalkaloids or tartaric acid derivatives are known (T. Mallat et al., Fine Chemicals through Heterogeneous Catalysis, Wiley-VCH, 2001, p. 449 ff).

Also, Ferrand et al. (Tetrahedron: Asymmetry, 13, 2002, pp. 1379 to 1384) describe the use of rhodium, ruthenium and iridium complexes with chiral diamines for the hydrogenation of ketoesters.

A common disadvantage of all these processes is that they allow at best a moderate enantiomeric excess.

There was therefore a need to provide catalysts which make possible high yields and enantioselectivities in particular in a process for preparing enantiomerically enriched alpha- and beta-hydroxycarboxylic esters.

### SUMMARY OF THE INVENTION

In accordance with the foregoing, the present invention encompasses compounds of the formula (I)

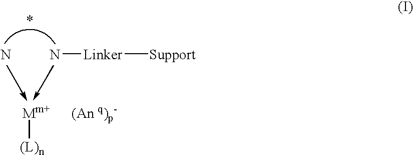

where

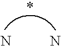

is an enantiomerically enriched chiral nitrogen compound,

Linker is a radical which is bonded both covalently to the enantiomerically enriched chiral nitrogen compound and to the support,

Support is a micro-, meso- or macroporous support material,

(M^{m+}) is a metal having valency m

L is an anionic or uncharged ligand

n is one, two, three or four

(An^{q-}) is an anion having valency q and

p is (m−number of anionic ligands L)/q.

For the purposes of the invention, enantiomerically enriched compounds are enantiomerically pure compounds or mixtures of enantiomers of a compound in which one enantiomer is present in an enantiomeric excess, (also referred to hereinbelow as ee) relative to the other enantiomer. Preferably, this enantiomeric excess is 10 to 100% ee, particularly preferably 90 to 100% ee and very particularly preferably 95 to 100% ee.

For the purposes of the invention, all radical definitions, parameters and illustrations hereinabove and listed hereinbelow, in general or within areas of preference, i.e. the particular areas and areas of preference, may be combined as desired.

### DETAILED DESCRIPTION OF THE INVENTION

Alkyl, alkoxy, alkylene and alkenylene hereinbelow are each independently a straight-chain, cyclic, branched or unbranched alkyl, alkoxy, alkylene and alkenylene radical respectively, each of which may optionally be further substituted by C₁-C₄-alkoxy. The same applies to the nonaromatic moiety of an arylalkyl radical.

Illustrative but non-limiting examples of these radicals are as follows. C₁-C₄-Alkyl is, for example, methyl, ethyl, n-propyl, isopropyl, n-butyl, sec-butyl and tert-butyl, C₁-C₈-alkyl is additionally, for example, n-pentyl, 1-methylbutyl, 2-methylbutyl, 3-methylbutyl, neopentyl, 1-ethylpropyl, cyclohexyl, cyclopentyl, n-hexyl, 1,1-dimethylpropyl, 1,2-dimethylpropyl, 1,2-dimethylpropyl, 1-methylpentyl, 2-methylpentyl, 3-methylpentyl, 4-methylpentyl, 1,1-dimethylbutyl, 1,2-dimethylbutyl, 1,3-dimethylbutyl, 2,2-dimethylbutyl, 2,3-dimethylbutyl, 3,3-dimethylbutyl, 1-ethylbutyl, 2-ethylbutyl, 1,1,2-trimethylpropyl, 1,2,2-trimethylpropyl, 1-ethyl-1-methylpropyl, 1-ethyl-2-methylpropyl, 1-ethyl-2-methylpropyl, n-heptyl and n-octyl, and C₁-C₂₀-alkyl is further additionally, for example, adamantyl, the isomeric menthyls, n-nonyl, n-decyl and n-dodecyl.

C₁-C₄-Alkoxy is, for example, methoxy, ethoxy, n-propoxy, isopropoxy, n-butoxy, sec-butoxy and tert-butoxy, C₁-C₈-alkoxy is additionally, for example, n-pentoxy, 1-methylbutoxy, 2-methylbutoxy, 3-methylbutoxy, neopentoxy, 1-ethylpropoxy, cyclohexoxy, cyclopentoxy, n-hexoxy and n-octoxy, and C₁-C₂₀-alkoxy is further additionally, for example, adamantoxy, the isomeric menthoxy radicals, n-decoxy and n-dodecoxy.

C₁-C₄-Alkylene is, for example, methylene, 1,1-ethylene, 1,2-ethylene, 1,1-propylene, 1,3-propylene, 1,4-butylene, and C₁-C₈-alkylene is additionally, for example, 1,2-cyclohexylene and 1,2-cyclopentylene.

C₂-C₈-Alkenylene is, for example, 1,1-ethenylene 2-ethoxy-1,1-ethenylene and 2-methoxy-1,1-ethenylene.

Haloalkyl, haloalkoxy and haloalkylene are each independently a straight-chain, cyclic, branched or unbranched alkyl radical and alkoxy radical and alkylene radical respectively, each of which is singly, multiply or fully substituted by halogen atoms.

For example, C₁-C₂₀-haloalkyl is trifluoromethyl, chloromethyl, 2-chloroethyl, 2,2,2-trifluoroethyl, pentafluoroethyl, nonafluorobutyl, heptafluoroisopropyl, perfluorooctyl, perfluorodecyl and perfluorohexadecyl.

Aryl is in each case independently a heteroaromatic radical having 5 to 14 framework carbon atoms of which no, one, two or three framework carbon atoms per cycle, but at least one framework carbon atom in the entire molecule, may be substituted by heteroatoms selected from the group of nitrogen, sulphur or oxygen, or and is preferably a carbocyclic aromatic radical having 6 to 14 framework carbon atoms.

Examples of carbocyclic aromatic radicals having 6 to 14 framework carbon atoms are phenyl, biphenyl, naphthyl, phenanthrenyl, anthracenyl or fluorenyl, heteroaromatic radicals having 5 to 14 framework carbon atoms of which no, one, two or three framework carbon atoms per cycle, but at least one framework carbon atom in the entire molecule, may be substituted by heteroatoms selected from the group of nitrogen, sulphur or oxygen are, for example, pyridinyl, oxazolyl, benzofuranyl, dibenzofuranyl or quinolinyl.

The carbocylic aromatic radical or heteroaromatic radical may also be substituted by up to five identical or different substituents per cycle which are selected, for example, from the group of nitro, cyano, chlorine, fluorine, C₁-C₁₂-alkyl, C₁-C₁₂-haloalkyl, C₁-C₁₂-haloalkoxy, C₁-C₁₂-haloalkylthio, C₁-C₁₂-alkoxy, di(C₁-C₈-alkyl)amino or tri(C₁-C₆-alkyl)siloxyl.

Arylene is an aryl radical which has a further bonding site on the aromatic framework and is therefore divalent.

Arylalkyl is in each case independently a straight-chain, cyclic, branched or unbranched alkyl radical as defined above which may be singly, multiply or fully substituted by aryl radicals as defined above.

Arylalkylene is an arylalkyl radical which has a further bonding site on the aromatic framework and is therefore divalent.

Areas of preference for compounds of the formula (I) are defined hereinbelow:

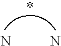

is preferably an enantiomerically enriched chiral nitrogen compound of the formula (II)

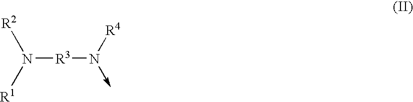

where

the arrow indicates the bonding point to the linker and

R¹, R² and R⁴ are each independently hydrogen, C₁-C₈-alkyl, C₅-C₁₅-arylalkyl or C₄-C₁₄-aryl or NR¹R² as a whole is a cyclic amino radical having a total of 4 to 20 carbon atoms,

R³ is a divalent radical having 2 to 30 carbon atoms or

R³ and at least one of the radicals R¹, R² and R⁴ together are part of a cyclic amino radical having a total of 4 to 20 carbon atoms.

Preferred compounds of the formula (II) are those in which

R¹, R² and R⁴ are each independently hydrogen, C₁-C₈-alkyl, C₅-C₁₅-arylalkyl or C₄-C₁₄-aryl or NR¹R² as a whole is a 5- or 6-membered monocyclic amino radical which is optionally mono-, di-, tri- or tetrasubstituted on the carbon framework by C₁-C₄-alkyl and

R³ is a divalent radical which is selected from the group of C₂-C₈-alkylene which may optionally be further mono- or disubstituted by C₄-C₁₄-aryl radicals, C₅-C₁₅-arylalkylene, C₄-C₁₄-arylene or bis(C₄-C₁₄-arylene) or R³ and one of the radicals R¹, R² and R⁴ together are part of a 5- or 6-membered monocyclic amino radical which is optionally additionally mono-, di-, tri- or tetrasubstituted on the carbon framework by C₁-C₄-alkyl.

Particularly preferred compounds of the formula (II) are those in which

R¹, R² and R⁴ are each independently hydrogen, methyl or ethyl and

R³ is a divalent radical which is selected from the group of 1,2-bis(C₄-C₁₄-aryl)-1,2-ethylene, 1,2-cyclohexylene, 1,1′-2,2′-bis(C₄-C₁₄-arylene) or

R³ and one of the radicals R¹, R and R⁴ together are part of a pyrrolidinyl or piperidinyl radical.

Very particularly preferred compounds of the formula (II) are those which are derived from the following compounds:

(1R,2R)-1,2-diphenylethylenediamine, (1S,2S)-1,2-diphenylethylenediamine, (1R,2R)-1,2-dimethylethylenediamine, (1S,2S)-1,2-dimethylethylenediamine, (1R,2R)-1,2-cyclohexylenediamine, (1S,2S)-1,2-cyclohexylenediamine, (S)-2-aminomethyl-1-ethylpyrrolidine, (R)-2-aminomethyl-1-ethylpyrrolidine, (S)-2-aminomethyl-1-methylpyrrolidine, (R)-2-aminomethyl-1-methylpyrrolidine, (R)-1,1′-diamino-2,2′-binaphthyl, (S)-1,1′-diamino-2,2′-binaphthyl, (R)-1,1′-diamino-6,6′-dimethoxy-2,2′-biphenyl and (S)-1,1′-diamino-6,6′-dimethoxy-2,2′-biphenyl, and even greater preference is given to (R)-2-aminomethyl-1-ethylpyrrolidine and (S)-2-aminomethyl-1-methylpyrrolidine.

Support is preferably a micro- or mesoporous support material. The terms micro-, meso- and for that matter macroporous, and the nomenclature of the zeolites are to be interpreted in accordance with IUPAC (McCusker et al. Pure Appl. Chem, vol. 73, No. 2, pp. 381-394, 2001). Examples of suitable support materials include silica gels, or zeolites of the MOR, X, Y, MCM, ZSM the, FAU, MFI, L, BEA, FER, A and SBA type or those of the AlPO, MAlPO and SAPO type, and the zeolites mentioned may optionally be isomorphically substituted. Particular preference is given to mesoporous zeolites, in particular those of the MCM type, for example MCM-41.

Preferred linker-support combinations are those which are obtainable by initially organically modifying the surface of the support in such a way that it has one or more functionalities after the modification (referred to hereinbelow as activated support) and that it is bonded via these functionalities to the above-defined enantiomerically enriched chiral nitrogen compounds. Particularly preferred functionalities are those which may react with amines to increase the valency of the amine (e.g. form tertiary amines from secondary amines or form secondary amines from primary amines). Examples of such functionalities include chlorine, bromine or iodine atoms, and also perfluoroacylate or sulphonate radicals.

The organic modifications described, i.e. the preparative methods for activated supports, are sufficiently well known and may be carried out in a manner known per se, for example, by

reacting the support with a chlorinating agent, for example carbon tetrachloride, thionyl chloride, titanium tetrachloride or phosphorus pentachloride (see also Beck et al. J. Am. Chem. Soc 1992, 114, 10834) and subsequently reacting with functionalized alcohols or alkoxysilanes or

reacting the support with silicon tetrachloride, subsequently reacting with secondary amines and reacting further with functionalized alcohols or alkoxysilanes (see also Petrucci et al. Bull. Chem. Soc. Japan, 1990, 63, 988) silazanes or preferably by

reacting the support with silicon tetrachloride or chlorosilanes of the SiClᵣ(C₁-C₈-alkyl)ₛ(C₄-C₁₄-Aryl)ₜ(C₅-C₁₅-arylalkyl)ᵤ type where r is one, two or three and r+s+t+u=4, and subsequently reacting with functionalized alcohols, chlorosilanes or alkoxysilanes.

Particularly preferred activated supports are those which are obtainable by reacting supports with chlorosilanes of the SiClᵣ(C₁-C₈-alkyl)ₛ(C₄-C₁₋₄-aryl)ₜ(C₅-C₁₅-arylalkyl)ᵤ type where r is one, two or three and r+s+t+u=4 and subsequently reacting with functionalized alkoxysilanes or halosilanes of the formulae (IIIa) or (IIIb)

Hal-(C₂-C₁₂-alkylene)-Si[O(C₁-C₈-alkyl)]₃ (IIIa)

Hal-(C₂-C₁₂-alkylene)-SiHal₃ (IIIb)

where, in formula (III),

Hal is chlorine or bromine.

Very particularly preferred activated supports are those which are obtained by reacting supports with diphenyldichlorosilane and subsequently reacting with 3-bromopropyltrichlorosilane.

Also in formula (I),

(M^{m+}) is preferably cobalt in the formal oxidation states 0, +2 and +3, rhodium and iridium in the formal oxidation states +1 and +3, nickel, palladium and platinum in the formal oxidation states 0 and +2 and also ruthenium in the formal oxidation state +2, and preference is given to Rh^{I}, Ir^{I} and Pd^{II}.

L is preferably the following ligand types: monoolefins, for example ethylene, cyclooctene and cyclohexene, diolefins, for example 1,5-cyclooctadiene (cod), norbornadiene (nbd) and butadiene, nitrites such as acetonitrile (ACN), benzonitrile and benzylnitrile, aromatics such as benzene, mesitylene and cymene, and also anionic ligands such as allyl, methylallyl, phenylallyl, C₁-C₈-alkyl acylacetonates, C₁-C₈-alkyl acylates, chloride, bromide and iodide.

(An^{q-}) is preferably non-coordinating or weakly coordinating anions, for example nitrate, perchlorate, sulphate, hexafluorophosphate, hexafluoroantimonate, hexachloroantimonate, borates, for example tetrafluoroborate and tetraphenylborate or sulphonates, for example trifluoromethanesulphonate and nonafluorobutanesulphonate.

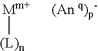

as an entire fragment is particularly preferably Rh(cod)BF₄, Ir(cod)BF₄, Rh(cod)PF₆, Ir(cod)PF₆, Rh(cod)SbF₆, Ir(cod)SbF₆, Rh(cod)ClO₄, Ir(cod)ClO₄, Rh(nbd)BF₄, Ir(nbd)BF₄, Rh(nbd)PF₆, Ir(nbd)PF₆, Rh(nbd)SbF₆, Ir(nbd)SbF₆, Rh(nbd)ClO₄, Ir(nbd)ClO₄, Pd(allyl)BF₄, Pd(allyl)PF₆ and Pd(ACN)₂(BF₄)₂.

Very particularly preferred compounds of the formula (I) are those of the formulae (Ia), (Ib), (Ic) and (Id)

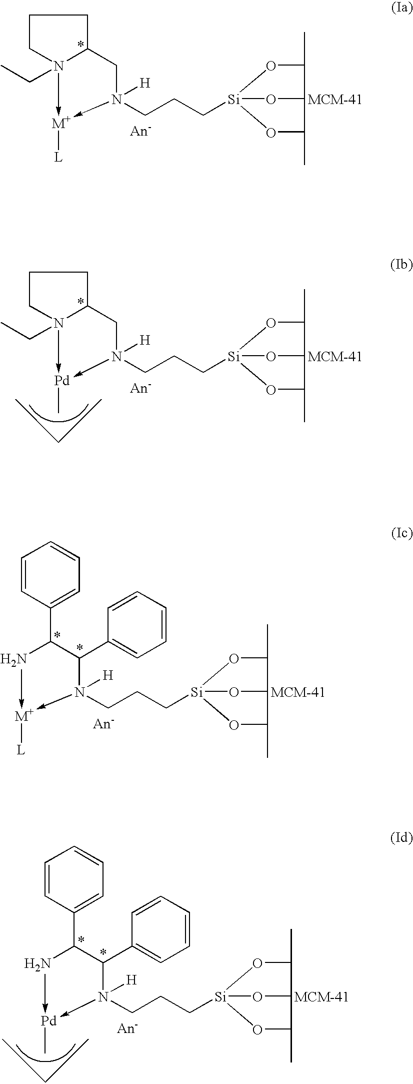

where, in each case,

marks a stereogenic centre which is either R- or S-configured, with the proviso that mesoforms are excluded (compounds of the formula (Ic) and (Id))

M⁺ is rhodium^{I} or iridium^{I} and

L is cod or nbd and

An⁻ is perchlorate, hexafluorophosphate, trifluoromethanesulphonate or tetrafluoroborate.

To prepare the compounds of the formula (I), in particular those of the formulae (Ia) to (Id), the procedure is preferably that,

in a step A), an activated support of the formula (IV)

Hal-Linker-Support (IV)

where linker and support have the definitions and areas of preference specified under the formula (I)

are reacted with enantiomerically enriched chiral nitrogen compounds of the formula (IIa)

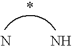

where the definitions and areas of preference specified under the formula (I) apply, optionally in the presence of an organic solvent, and, in a step B), the compounds of the formula (V) obtained in this way

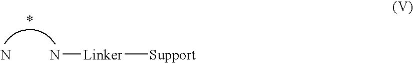

are reacted with transition metal compounds, optionally in the presence of an organic solvent, to give compounds of the formula (I).

The invention also encompasses the compounds of the formula (V), with the areas of preference specified under the formula (I) applying in the same manner.

Preferred transition metal compounds are those of the formula (VIa)

M¹(An¹)ₚ₁ (VIa)

where

M¹ is ruthenium, rhodium, iridium, nickel, palladium or platinum and

An¹ is chloride, bromide, acetate, nitrate, methanesulphonate, trifluoromethanesulphonate or acetylacetonate and

p1 for ruthenium, rhodium and iridium is 3, and for nickel, palladium and platinum is 2,

or transition metal compounds of the formula (VIb)

M²(An²)ₚ₂L¹₂ (VIb)

where

M² is ruthenium, rhodium, iridium, nickel, palladium or platinum and

An² is chloride, bromide, acetate, methanesulphonate, trifluoromethanesulphonate, tetrafluoroborate, hexafluorophosphate perchlorate, hexafluoroantimonate, tetra(bis-3,5-trifluoromethylphenyl)borate or tetraphenylborate and

p2 is rhodium and iridium is 1, and for nickel, palladium, platinum and ruthenium is 2 and

L¹ is in each case a C₂-C₁₂-alkene, for example ethylene or cyclooctene, or a nitrile, for example acetonitrile, benzonitrile or benzyl nitrile, or

L¹₂ together is a (C₄-C₁₂)-diene, for example norbornadiene or 1,5-cyclooctadiene,

or transition metal compounds of the formula (VIc)

[M³L²An³₂]₂ (VIc)

where

M³ is ruthenium and

L² is cod, nbd, allyl, methylallyl or aryl radicals, for example cymene, mesitylene, benzene and

An³ is chloride, bromide, acetate, methanesulphonate, trifluoromethanesulphonate, tetrafluoroborate, hexafluorophosphate perchlorate, hexafluoroantimonate, tetra(bis-3,5-trifluoromethylphenyl)borate or tetraphenylborate,

or transition metal compounds of the formula (VId)

M⁴ₚ₃[M⁵(An³)₄] (VId),

where

M⁵ is palladium, nickel, iridium or rhodium and

An³ is chloride or bromide and

M⁴ is lithium, sodium, potassium, ammonium or organic ammonium and

p³ for rhodium and iridium is 3, and for nickel, palladium and platinum is 2,

or transition metal compounds of the formula (VIe)

[M⁶(L³)₂]An⁴ (VIe)

where

M⁶ is iridium or rhodium and

L³ is a (C₄-C₁₂)-diene, for example norbornadiene or 1,5-cyclooctadiene, and

An⁴ is a non-coordinating or weakly coordinating anion, for example methanesulphonate, trifluoromethanesulphonate, tetrafluoroborate, hexafluorophosphate perchlorate, hexafluoroantimonate, tetra(bis-3,5-trifluoromethylphenyl)borate or tetraphenylborate.

Examples of further suitable transition metal compounds include Ni(cod)₂, Pd₂(dibenzylideneacetone)₃, cyclopentadienyl₂Ru, Rh(acetylacetonate)(CO)₂, Ir(pyridine)₂(cod)OTf or multinuclear bridged complexes, for example [Pd(allyl)Cl]₂, [Pd(allyl)Br]₂, [Rh(cod)Cl]₂, [Rh(cod)Br]₂, [Rh(ethene)₂Cl]₂, [Rh(cyclooctene)₂Cl]₂, [Ir(cod)Cl]₂ and [Ir(cod)Br]₂, [Ir(ethene)₂Cl]₂ and [Ir(cyclooctene)₂Cl]₂.

Particularly preferred transition metal compounds are: [Pd(allyl)Cl]₂, [Pd(allyl)Br]₂, [Rh(cod)Cl]₂, [Rh(cod)₂Br], [Rh(cod)₂]ClO₄, [Rh(cod)₂]BF₄, [Rh(cod)₂]PF₆, [Rh(cod)₂]Otf (Otf=triflate), [Rh(cod)₂]BPh₄, [Rh(cod)₂]SbF₆ RuCl₂(cod), [(cymene)RuCl₂]₂, [(benzene)RuCl₂]₂, [(mesitylene)RuCl₂]₂, [(cymene)RuBr₂]₂, [(cymene)RuI₂]₂, [(cymene)Ru(BF₄)₂]₂, [(cymene)Ru(PF₆)₂]₂, [(cymene)Ru(BPh₄)₂]₂, [(cymene)Ru(SbF₆)₂]₂, [Ir(cod)₂Cl]₂, [Ir(cod)₂]PF₆, [Ir(cod)₂]ClO₄, [Ir(cod)₂]SbF₆ [Ir(cod)₂]BF₄, [Ir(cod)₂]OTf, [Ir(cod)₂]BPh₄, [Rh(nbd)Cl]2 (nbd=norbornadiene), [Rh(nbd)₂Br], [Rh(nbd)₂]ClO₄, [Rh(nbd)₂]BF₄, [Rh(nbd)₂]PF₆, [Rh(nbd)₂]OTf, [Rh(nbd)₂]BPh₄, [Rh(nbd)₂]SbF₆RuCl₂(nbd), [Ir(nbd)₂]PF₆, [Ir(nbd)₂]ClO₄, [Ir(nbd)₂]SbF₆ [Ir(nbd)₂]BF₄, [Ir(nbd)₂]OTf, [Ir(nbd)₂]BPh₄, Ir(pyridine)₂(nbd)OTf, [Ru(DMSO)₄C₂], [Ru(ACN)₄Cl₂], [Ru(PhCN)₄Cl₂] and [Ru(cod)Cl₂]ₙ, and even greater preference is given to [Pd(allyl)Cl]₂, Rh(cod)₂OTf, Rh(cod)₂ PF₆, Rh(cod)₂SbF₆, Ir(cod)₂BF₄, Rh(cod)₂OTf, Ir(cod)₂ PF₆, Ir(cod)₂SbF₆ and Ir(cod)₂BF₄.

It is pointed out that it is often advantageous when using halide-containing transition metal compounds to additionally use silver or potassium salts of non-coordinating or weakly coordinating anions as defined above in an approximately equimolar amount to the halide present.

Useful organic solvents for steps A) and B) are typically aliphatic or aromatic, optionally halogenated hydrocarbons, for example petroleum ether, benzene, toluene, the isomeric xylenes, chlorobenzene, the isomeric dichlorobenzenes, hexane, cyclohexane, dichloromethane or chloroform, and preferably ethers, such as diethyl ether, diisopropyl ether, dioxane, tetrahydrofuran, methyl tert-butyl ether or ethylene glycol dimethyl ether or ethylene glycol diethyl ether. Particularly preferred organic solvents are toluene, diethyl ether, tetrahydrofuran and methyl tert-butyl ether.

The weight ratio of enantiomerically enriched chiral nitrogen compounds to activated support may be, for example and with preference, 0.02:1 to 100:1, particularly preferably 0.1:1 to 5:1 and very particularly preferably 0.1:1 to 1:1. The use of greater amounts of enantiomerically enriched chiral nitrogen compounds is possible but uneconomic.

The weight ratio of transition metal compound to compounds of the formula (V) may be, for example and with preference, 0.005:1 to 1:1, particularly preferably 0.01:1 to 0.2:1 and very particularly preferably 0.02:1 to 0.1:1.

In step A), the reaction temperature is, for example and with preference, 0 to 100° C., particularly preferably 20 to 80° C. and very particularly preferably 40 to 60° C.

In step B), the reaction temperature is, for example and with preference, 20° C. to 80° C., particularly preferably 0 to 60° C. and very particularly preferably 10 to 30° C.

The compounds of the formula (I) may be worked up in a manner known per se by filtration and/or centrifugation and/or sedimentation and optionally subsequent washing with organic solvent, and the washing may be carried out, for example, batchwise or continuously. For storage purposes, the compounds of the formula (I) are preferably dried.

The compounds of the formula (I) may be used directly as catalyst for asymmetric reactions.

The invention therefore also encompasses catalysts which comprise compounds of the formula (I).

The invention also encompasses a process for catalytically preparing enantiomerically enriched compounds, which is characterized in that the catalysts used are those which comprise compounds of the formula (I).

Preferred processes for preparing enantiomerically enriched compounds are asymmetric hydrogenations, for example hydrogenations of prochiral C═C bonds such as prochiral enamines, olefins, enol ethers; C═O bonds such as prochiral ketones and C═N bonds such as prochiral imines. Particularly preferred asymmetric hydrogenations are hydrogenations of prochiral ketones, in particular alpha- and beta-ketocarboxylic esters.

Preferred alpha- and beta-ketocarboxylic esters are compounds of the formula (VII)

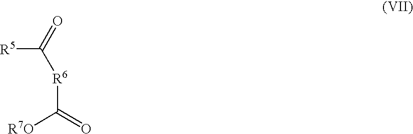

where

R⁵ and R⁷ are each independently C₁-C₁₂-alkyl, C₁-C₁₂-haloalkyl, C₅-C₁₅-arylalkyl or C₄-C₁₄-aryl and

R⁶ is absent or is 1,1-(C₁-C₄-alkylene).

Preferably, R⁵ and R⁷ are each independently C₁-C₄-alkyl or phenyl, and R⁶ is methylene or is absent.

Particularly preferred compounds of the formula (VII) are methyl phenylglyoxylate and ethyl chloroacetoacetate.

The hydrogenation according to the invention of alpha- and beta-ketocarboxylic esters provides enantiomerically enriched compounds of the formula (VIII)

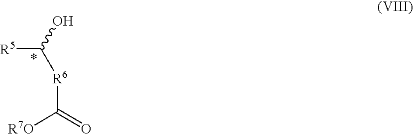

where

* marks a stereogenic centre which is S- or R-configured and

R⁵, R⁶ and R⁷ each have the definitions and areas of preference specified under the formula (VII).

The compounds which can be prepared according to the invention are suitable in particular as optical resolution reagents or in a process for preparing pharmaceuticals or agrochemicals.

In a preferred embodiment of asymmetric hydrogenations according to the invention, the reaction temperature is 0 to 200° C., preferably 10 to 150° C., and the partial hydrogen pressure is, for example, 0.1 to 200 bar, preferably 0.9 to 100 bar and particularly preferably 4 to 30 bar.

Useful solvents for asymmetric hydrogenations according to the invention are in particular aliphatic or aromatic, optionally halogenated hydrocarbons, for example petroleum ether, benzene, toluene, the isomeric xylenes, chlorobenzene, the isomeric dichlorobenzenes, hexane, cyclohexane, dichloromethane or chloroform, ethers such as diethyl ether, diisopropyl ether, dioxane, tetrahydrofuran, methyl tert-butyl ether or ethylene glycol dimethyl ether or ethylene glycol diethyl ether, and preferably alcohols such as methanol, ethanol and isopropanol.

The weight ratio of compounds of the formula (I) to substrate may be, for example, 1:1 to 1:10 000, preferably 1:5 to 1:1000.

The advantage of the present invention is that heterogeneous catalysts may be prepared in high yields and in an efficient manner and that these catalysts allow high conversions and enantioselectivities in asymmetric syntheses. This fact is to be regarded as particularly surprising in that the non-immobilized analogues to compounds of the formula (I) allow only very low enantioselectivities, if any at all, as the comparative examples show.

### EXAMPLES

### EXAMPLE 1

### For Comparison

### Preparation of [palladium(η³-allyl)((S)-2-aminomethyl-1-ethylpyrrolidine)]-BF₄

[Pd(3-allyl)Cl]₂ (70 mg, 0.19 mmol) were dissolved in THF (10 ml), admixed with AgBF₄ (80 mg, 0.41 mmol) and stirred for one hour. The mixture was filtered, the amine (48 mg, 0.38 mmol) was added to the filtrate and the mixture was stirred for 30 min. A white solid precipitated out. The further addition of 20 ml of hexane resulted in further product precipitating out. The solution was filtered, washed with hexane (2×20 ml) and diethyl ether (2×20 ml) and the residue was dried under reduced pressure to obtain a white powder (100 mg, 73% of theory).

Anal: Calculated: C₁₀H₂₁N₂PdBF₄: C, 33.14; H, 5.80; N, 7.73. Found: C, 33.40; H, 5.81; N, 7.55.

¹H NMR (CD₃OD): 1.30-4.0 (m, CH₂ allyl and amine, 18H) 5.55 (m, CH, 1H).

¹³C NMR (CD₃OD): 14.8(1), 22.2(4), 25.3(5), 44.2(7), 50.1(2), 53.2(3), 60.3 (CH₂ allyl), 69.9(6) 116.3(CH, allyl).

ESI=275 (M⁺), 233 (M⁺-allyl)

### EXAMPLE 2

Preparation of Covalently Immobilized [palladium(η³-allyl)((S)-2-aminomethyl-1-ethylpyrrolidine)]BF₄

a) Activation of MCM-41

Dichlorodiphenylsilane (0.48 g) was added to dried, calcined MCM-41 (2.0 g) in THF (15 ml) and stirred for one hour. The solution was then cooled to −78° C. and admixed with 3-bromopropyltrichlorosilane (1.10 g). The mixture was allowed to warm slowly to room temperature and stirred for a further 8 hours. The mixture was subsequently stirred at 50° C. for one hour. The activated support MCM-41 was filtered off and purified by Soxhlet extraction using THF. Finally, the support was dried under reduced pressure.

Anal: C, 4.70; H, 0.87.

b) Coupling with (S)-2-aminomethyl-1-ethylpyrrolidine

The activated support MCM-41 (700 mg) in THF (15 ml) together with the amine (0.15 ml) was heated at 50° C. for 20 hours. Afterwards, the product was filtered and purified by Soxhlet extraction using THF. Finally, the product was dried under reduced pressure.

Anal: C, 9.82; H, 2.0; N, 1.51.

c) Complexing with Palladium

In a Schlenk vessel, [PdCl(allyl)]₂ (30 mg, 0.08 mmol) and AgBF₄ (30 mg, 0.15 mmol) were dissolved in THF (10 ml) and stirred for one hour. The solution was filtered, admixed with the modified MCM-41 from b) and stirred for four hours. The white solid was filtered, washed with THF (4×20 ml) and dried under reduced pressure.

Anal: C, 11.67; H, 2.32; N, 1.46.

### EXAMPLE 3

### For Comparison

Preparation of [palladium(η³-allyl)((1R,2R)-1,2-diphenylethylenediamine) ]BF₄

[Pd(η³-allyl)Cl]₂ (70 mg, 0.19 mmol) were dissolved in THF (10 ml), admixed with AgBF₄ (80-mg, 0.41 mmol) and stirred for one hour. The mixture was filtered, the amine (80 mg, 0.38 mmol) was added to the filtrate and the mixture was stirred for 30 min. A white solid precipitated out. The further addition of 20 ml of hexane resulted in further product precipitating out. The solution was filtered, washed with hexane (2×20 ml) and diethyl ether (2×20 ml) and the residue was dried under reduced pressure to obtain a white powder (156 mg, 88% of theory).

Anal.: Calculated for C₁₇H₂₁N₂RhBF₄: C, 45.74; H, 4.71; N, 6.27. Found: C, 45.25; H, 4.62; N, 5.98.

¹H NMR (CD₃OD) 2.98 (m, CHₐₙₜᵢ, 2H), 4.02 (s, NCH, 2H), 4.20 (m, CH_{syn}, 2H), 5.47 (m, CH_{central}, 1H), 7.1-7.25 (m, Ph, 10H). ³C NMR (CD₃OD) δ6.72 (CH₂), 64.24 (NCH), 114.87 (CH), 127.0, 127.70, 128.25, 139.73 (Ph).

+ve ESI=359 (M+).

### EXAMPLE 4

Preparation of Covalently Immobilized [palladium(η³-allyl)((1R,2R)-1,2-diphenylethylenediamine)]BF₄

a) Activation of MCM-41

Dichlorodiphenylsilane (0.48 g) was added to dried, calcined MCM-41 (2.0 g) in THF (15 ml) and stirred for one hour. The solution was then cooled to −78° C. and admixed with 3-bromopropyltrichlorosilane (1.10 g). The mixture was allowed to warm slowly to room temperature and stirred for a further 8 hours. The mixture was subsequently stirred at 50° C. one hour for one hour. The activated support MCM-41 was filtered and purified by Soxhlet extraction using THF. Finally, the support was dried under reduced pressure.

Anal: C, 4.70; H, 0.87.

b) Coupling with (1R,2R)-1,2-diphenylethylenediamine

The activated support MCM-41 (500 mg) in THF (15 ml) together with the amine (150 mg) was heated to reflux for 20 hours. Afterwards, the product was filtered and purified by Soxhlet extraction using THF. Finally, the product was dried under reduced pressure.

Anal: C, 9.72; H, 1.92; N, 0.15.

c) Complexing with Palladium

In a Schlenk vessel, [PdCl(allyl)]₂ (55 mg, 0.15 mmol) and AgBF₄ (60 mg, 0.3 mmol) were dissolved in THF (10 ml) and stirred for one hour. The solution was filtered, admixed with the modified MCM-41 from b) and stirred for four hours. The solid was filtered, washed with THF (4×20 ml) and dried under reduced pressure.

Anal: C, 10.67; H, 2.31; N, 0.13.

### EXAMPLE 5

### For Comparison

Preparation of [Rh(cod)((1R,2R)-1,2-diphenylethylenediamine)]BF₄

[RhCl(cod)]₂ (64 mg, 0.13 mmol) was dissolved in THF (10 ml), AgCF₃SO₃ (50 mg, 0.26 mmol) was added and the solution was stirred for one hour. The solution was subsequently filtered, the filtrate admixed with (1R,2R)-1,2-diphenylethylenediamine (50 mg, 0.26 mmol) and the resulting solution was stirred for one hour. Subsequently, the solution was concentrated under reduced pressure and admixed with hexane (25 ml), and the product precipitated out. The mixture was filtered, and the product was washed with hexane (2×20 ml) and diethyl ether (2×20 ml) and dried under reduced pressure. A yellow powder was obtained (185 mg, 90%).

Anal: Calculated for C₂₂H₂₈N₂RhBF₄C, 51.76; H, 5.50; N, 5.50. Found: C, 51.44; H, 5.57; H, 5.29.

¹H NMR (CD₃OD) 1.95 (br m, CH₂ 4H), 2.46 (br m, CH₂, 4H), 4.01 (s, NCH, 2H), 4.24 (m, CH, 2H), 4.35 (m, CH, 2H), 7.1-7.3 (m, Ph, 10H).

¹³C NMR (CD₃OD) 31.6 (CH₂), 66.3 (NCH) 81.4 (CH), 128.5, 129.2, 129.6, 140.5 (Ph).

+ve ESI=423 (M⁺).

### EXAMPLE 6

Preparation of Covalently Immobilized [Rh(cod)((1R,2R)-1,2-diphenylethylene-diamine)] BF₄

a) Activation of MCM-41

Dichlorodiphenylsilane (0.48 g) was added to dried, calcined MCM-41 (2.0 g) in THF (15 ml) and stirred for one hour. The solution was then cooled to −78° C. and admixed with 3-bromopropyltrichlorosilane (1.10 g). The mixture was allowed to warm slowly to room temperature and stirred for a further 8 hours. The mixture was subsequently stirred at 50° C. one hour for one hour. The activated support MCM-41 was filtered and purified by Soxhlet extraction using THF. Finally, the support was dried under reduced pressure.

Anal: C, 4.70; H, 0.87.

b) Coupling with (1R,2R)-1,2-diphenylethylenediamine

The activated support MCM-41 (500 mg) in THF (15 ml) together with the amine (150 mg) was heated to reflux for 24 hours. Afterwards, the product was filtered and purified by Soxhlet extraction using THF. Finally, the product was dried under reduced pressure.

Anal: C, 9.72; H, 1.92; N, 0.15; Br, 1.30.

c) Complexing

In a Schlenk vessel, [RhCl(cod)]₂ (30 mg, 0.06 mmol) and AgBF₄ (30 mg, 0.15 mmol) were dissolved in THF (10 ml) and stirred for one hour. The solution was filtered, admixed with the modified MCM-41 from b) and stirred for four hours. The solution decolorized slowly. The yellow solid was filtered, washed with THF (4×20 ml) and dried under reduced pressure.

Anal: C, 11.23; H, 2.02; N, 0.12.

### EXAMPLE 7

### For Comparison

Preparation of [Rh(cod)((S)-2-aminomethyl-1-ethylpyrrolidine]BF₄

[RhCl(cod)]₂ (100 mg, 0.20 mmol) was dissolved in THF (10 ml), AgCF₃SO₃ (80 mg, 0.41 mmol) was added and the solution was stirred for one hour. The solution was subsequently filtered, the filtrate admixed with (S)-2-aminomethyl-1-ethylpyrrolidine (51.2 mg, 0.40 mmol) and the resulting solution was stirred for one hour. Subsequently, the solution was concentrated under reduced pressure and admixed with hexane (25 ml), and the product precipitated out. The mixture was filtered, and the product was washed with hexane (2×20 ml) and diethyl ether (2×20 ml) and dried under reduced pressure. A yellow powder was obtained (185 mg, 90%).

Anal.: Calculated for C₁₅H₂₈N₂RhBF₄: C, 42.25; H, 6.57; N, 6.57. Found: C, 42.79; H, 6.61; N, 6.59.

¹H NMR (CDCl₃) 1.76 (br m, 4H, CH₂ olefin), 2.45 (br m, 4H, CH₂ olefin), 1.55-3.30 (m, 14H, amine).

¹³C NMR (CDCl₃)=12.3 (1), 21.7 (4), 24.3 (5), 45.9 (7), 51.0 (2), 56.6 (3), 70.0 (6), 30.4, 30.7 (CH₂) 79.7, 83.6 (CH).

+ve ESI=339 (M⁺), 231 (M⁺-COD).

### EXAMPLE 8

Preparation of Covalently Immobilized [Rh(cod)((S)-2-aminomethyl-1-ethylpyrrolidine]BF₄

a) Activation of MCM-41

Dichlorodiphenylsilane (0.48 g) was added to dried, calcined MCM-41 (2.0 g) in THF (15 ml) and stirred for one hour. The solution was then cooled to −78° C. and admixed with 3-bromopropyltrichlorosilane (1.10 g). The mixture was allowed to warm slowly to room temperature and stirred for a further 8 hours. The mixture was subsequently stirred at 50° C. one hour for one hour. The activated support MCM-41 was filtered and purified by Soxhlet extraction using THF. Finally, the support was dried under reduced pressure.

Anal: C, 4.70; H, 0.87.

b) Coupling with (S)-2-aminomethyl-1-ethylpyrrolidine

The activated support MCM-41 (700 mg) in THF (15 ml) together with the amine (0.15 ml) was heated at 50° C. for 20 hours. Afterwards, the product was filtered and purified by Soxhlet extraction using THF. Finally, the product was dried under reduced pressure.

Anal: C, 9.82; H, 2.0; N, 1.51.

c) Complexing with Palladium

In a Schlenk vessel, [RhCl(cod)]₂ (30 mg, 0.06 mmol) and AgBF₄ (30 mg, 0.15 mmol) were dissolved in THF (10 ml) and stirred for one hour. The solution was filtered, admixed with the modified MCM-41 from b) and stirred for four hours. The white solid was filtered, washed with THF (4×20 ml) and dried under reduced pressure.

Anal: C, 12.45; H, 2.45; N, 1.60.

The ¹⁹F MAS NMR spectrum confirmed the presence of the BF₄ anion.

### EXAMPLES 9 to 15

General Procedure for the Use of the Catalysts in Asymmetric Hydrogenations

The asymmetric hydrogenations were carried out in a high-pressure autoclave made of rust-free stainless steel and having a capacity of 150 ml. 10 mg in each case of the homogeneous catalyst or 50 mg in each case of the immobilized catalysts were transferred into the high-pressure autoclave under an inert atmosphere.

Methyl phenylglyoxylate (0.5 g), methanol (30 g) and an internal standard (cyclododecane) were added and the high-pressure autoclave was closed. The high-pressure autoclave and its inlets and outlets were subsequently inertized by flushing with nitrogen three times and, to test the seal, finally placed under a hydrogen pressure of 5 bar. Subsequently, the hydrogen pressure was increased to 20 bar, the high-pressure autoclave was brought to reaction temperature (313 K) and the contents were stirred with a mechanical stirrer at 400 rpm.

A miniaturized automatic withdrawal valve was used to take samples of the contents, in order to be able to investigate the progress of the reaction. At the end of the reaction, the high-pressure autoclave was cooled for two hours in an ice bath and decompressed, and the products were identified by gas chromatography (GC, Varian, Model 3400 CX) using a chiral column (Chiraldex, 20 m×0.25 mm).

The results of the hydrogenation experiments are compiled in the following table:

| | Catalyst | | Reaction | | |
|---|---|---|---|---|---|
| | from | Temperature | time | Conversion | ee |
| Example | example | [° C.] | [h] | [%] | [%] |
| 9 | 1 (for comp.) | 40 | 2 | 97.3 | 0 |
| 10 | 1 for comp.) | 40 | 24 | 99.0 | 0 |
| 11 | 2 | 40 | 2 | 99.1 | 94.5 |
| 12 | 5 (for comp.) | 40 | 2 | 82.0 | 0 |
| 13 | 7 (for comp.) | 40 | 2 | 94.0 | 0 |
| 14 | 8 | 40 | 2 | 97.7 | 77.5 |
| 15 | 8 | 40 | 24 | 98.6 | 80.4 |

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. Compounds of the formula (I) 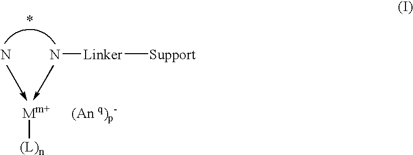
where 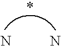
is an enantiomerically enriched chiral nitrogen compound,
Linker is a radical which is bonded both covalently to the enantiomerically enriched chiral nitrogen compound and to the support,
Support is a micro-, meso- or macroporous support material,
(M^{m+}) is a metal having valency m
L is an anionic or uncharged ligand
n is one, two, three or four
(An^{q-}) is an anion having valency q and
p is (m−number of anionic ligands L)/q.

2. Compounds according to claim 1, characterized in that 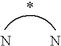
is an enantiomerically enriched chiral nitrogen compound of the formula (II) 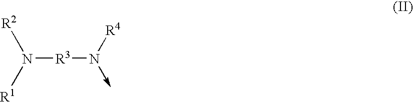
where
the arrow indicates the bonding point to the linker and
R¹, R² and R⁴ are each independently hydrogen, C₁-C₈-alkyl, C₅-C₁₅-arylalkyl or C₄-C₁₄-aryl or NR¹R² as a whole is a cyclic amino radical having a total of 4 to 20 carbon atoms,
R³ is a divalent radical having 2 to 30 carbon atoms or
R³ and at least one of the radicals R¹, R² and R⁴ together are part of a cyclic amino radical having a total of 4 to 20 carbon atoms.

3. Compounds according to claim 2, characterized in that R¹, R² and R⁴ are each independently hydrogen, C₁-C₈-alkyl, C₅-C₁₅-arylalkyl or C₄-C₁₄-aryl or NR¹R² as a whole is a 5- or 6-membered monocyclic amino radical which is optionally mono-, di-, tri- or tetrasubstituted on the carbon framework by C₁-C₄-alkyl and
R³ is a divalent radical which is selected from the group of C₂-C₈-alkylene which may optionally be further mono- or diubstituted by C₄-C₁₄-aryl radicals, C₅-C₁₅-arylalkylene, C₄-C₁₄-arylene or bis(C₄-C₁₄-arylene) or
R³ and one of the radicals R¹, R² and R⁴ together are part of a 5- or 6-membered monocyclic amino radical which is optionally additionally mono-, di-, tri- or tetrasubstituted on the carbon framework by C₁-C₄-alkyl.

4. Compounds according to claim 1, characterized in that the support is a micro- or mesoporous support material.

5. Compounds according to claim 1, characterized in that the supports are silica gels or zeolites of the MOR, X, Y, MCM, ZSM, FAU, MFI, L, BEA, FER, A and SBA type or those of the AlPO, MAlPO and SAPO type, and the zeolites are optionally isomorphically substituted.

6. Compounds according to claim 1, characterized in that supports are mesoporous zeolites.

7. Compounds according to claim 1, characterized in that (M^{m+}) is cobalt in the formal oxidation states 0, +2 and +3, rhodium and iridium in the formal oxidation states +1 and +3, nickel, palladium and platinum in the formal oxidation states 0 and +2 or ruthenium in the formal oxidation state +2.

8. Compounds according to claim 1, characterized in that L is the following types of ligand: monoolefins, diolefins, nitriles, aromatics or anionic ligands.

9. Compounds according to claim 1, characterized in that (An^{q-}) is nitrate, perchlorate, sulphate, hexafluorophosphate, hexafluoroantimonate, hexachloroantimonate, borates or sulphonates.

10. Compounds according to claim 1, characterized in that they are of the formulae (Ia), (Ib), (Ic) and (Id) 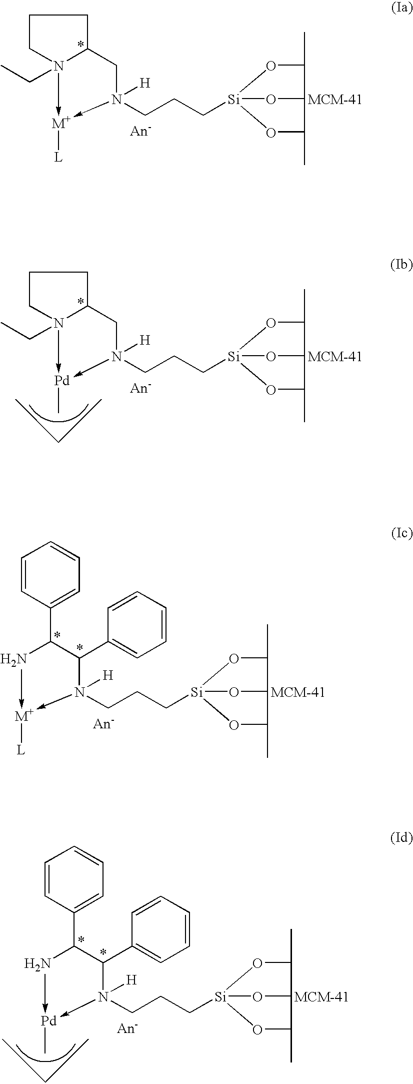
where, in each case,
* marks a stereogenic centre which is either R- or S-configured, with the proviso that mesoforms are excluded (compounds of the formula (Ic) and (Id))
M⁺ is rhodium^{I} or iridium^{I} and
L is cod or nbd and
An⁻ is perchlorate, hexafluorophosphate, trifluoromethanesulphonate or tetrafluoroborate.

11. Compounds of the formula (V) 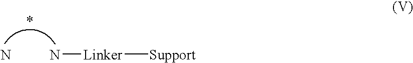
where 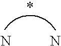
is an enantiomerically enriched chiral nitrogen compound,
Linker is a radical which is bonded both covalently to the enantiomerically enriched chiral nitrogen compound and to the support,
Support is a micro-, meso- or macroporous support material which is modified by the linker.

12. Catalysts comprising compounds according to claim 1.

13. A process for conducting asymmetric reactions comprising catalyzing the reactions with compounds of claim 1.

14. Process for catalytically preparing enantiomerically enriched compounds, comprising catalyzing the preparation with the compounds according to claim 1.

15. Process according to claim 14, characterized in that processes for preparing enantiomerically enriched compounds are asymmetric hydrogenations.

16. Process according to claim 14, characterized in that asymmetric hydrogenations are hydrogenations of α- and β-ketocarboxylic esters.

17. Process according to claim 16, characterized in that α- and β-ketocarboxylic esters are those of the formula (VII) 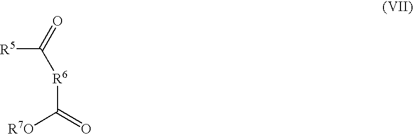
where
R⁵ and R⁷ are each independently C₁-C₁₂-alkyl, C₁-C₁₂-haloalkyl, C₅-C₁₅-arylalkyl or C₄-C₁₄-aryl and
R⁶ is absent or is 1,1-(C₁-C₄-alkylene).

18. Process according to claim 15, characterized in that the reaction temperature in the case of asymmetric hydrogenations is 0 to 200° C. and the partial hydrogen pressure is 0.1 to 200 bar.

19. Process according to claim 15, characterized in that solvents selected from the group consisting of aliphatic or aromatic, optionally halogenated, hydrocarbons, ethers and alcohols are used in the process.

20. Process according to claim 14, characterized in that the weight ratio of compounds to substrate is 1:1 to 1:10 000.

21. A process for preparing optical resolution reagents comprising providing compounds which have been prepared by a process according to claim 14.

22. A process for preparing agrochemicals or pharmaceuticals comprising providing compounds which have been prepared by a process according to claim 14.
